(19) United States
(12) Patent Application Publication
(10) Pub. No.: US 2024/0152239 A1
(43) Pub. Date: May 9, 2024

(54) Capacitance Module with Sensor on an Inside Substrate Surface

(71) Applicant: Cirque Corporation, Sandy, UT (US)

(72) Inventors: Paul Glad, Sandy, UT (US); Douglas Steck, Riverton, UT (US)

(73) Assignee: Cirque Corporation, Sandy, UT (US)

(21) Appl. No.: 17/983,965

(22) Filed: Nov. 9, 2022

(51) Int. Cl. G06F 3/044

(52) U.S. Cl. CPC G06F 3/0443; G06F 3/0446; G06F 2203/04107

(57) ABSTRACT

A capacitance module may include a first substrate having a first side and a second side opposite the first side, and a second substrate having a third side and a fourth side opposite the third side, the second side of the first substrate facing the third side of the second substrate. A first set of electrodes may be disposed on the second side of the substrate, and a second set of electrodes may be disposed on the second side of the substrate. The first set of electrodes and the second set of electrodes may be used to measure capacitance.

### FIELD OF THE DISCLOSURE

This disclosure relates generally to systems and methods for capacitance modules incorporated as touchpads.

### BACKGROUND

A capacitive touchpad may include multiple layers including sensor layers, shield layers, and other layers that may be stacked one over another and adhered together to form the touchpad. As a capacitive touchpad includes more layers and elements, the overall size of the capacitive touchpad may increase. It may be desirable to reduce the overall size of a capacitive touchpad. Capacitive touchpads with smaller footprints occupy less space in a device, which leaves extra space for other elements within the device, such as batteries, processors, and other elements. While reducing the overall size of a capacitive touchpad may be desirable, it may present a tradeoff in terms of touchpad functionality.

An example of a touchpad is disclosed in U.S. Pat. No. 8,633,916 issued to Jeffrey Traer Bernstein, et al. The reference describes electronic devices that use touch pads that have touch sensor arrays, force sensors, and actuators for providing tactile feedback. A touch pad may be mounted in a computer housing. The touch pad may have a rectangular planar touch pad member that has a glass layer covered with ink and contains a capacitive touch sensor array. Force sensors may be mounted under each of the four corners of the rectangular planar touch pad member. The force sensors may be sued to measure how much force is applied to the surface of the planar touch pad member by a user. Processed force sensor signals may indicate the presence of button activity such as press and release events. In response to detected button activity or other activity in the device, actuator drive signals may be generated for controlling the actuator. The user may supply settings to adjust signal processing and tactile feedback parameters.

Another example of a touchpad is disclosed in U.S. Pat. No. 20,150,084,868 issued to Matthew Dominic Tenuta. This reference describes a trackpad device that includes a top surface, a capacitive sensor operably coupled to the top surface, a resistive sensor disposed below the capacitive sensor and at least one controller operably coupled to the capacitive sensor and to the resistive sensor. The at least one controller and the capacitive sensor are configured to detect one or more objects on the top surface. The at least one controller and the resistive sensor are configured to detect the one or more objects on the top surface independent of the detection by the at least one controller and the capacitive sensor. The at least one controller is configured to determine locations of the one or more objects on the top surface using information from the detection by the at least one controller and capacitive sensor and information from the detection by the at least one controller and the resistive sensor.

Yet another example of a touchpad is disclosed in U.S. Pat. No. 11,054,932 issued to Qiliang Xu, et al. This reference describes an electronic device that includes an input device. The input device has an input/output module below or within a cover defining an input surface. The input/output module detects touch and/or force inputs on the input surface and provides haptic feedback to the cover. In some instances, a haptic device is integrally formed with a wall or structural element of a housing or enclosure of the electronic device.

Each of these references are herein incorporated by reference for all that they disclose.

### SUMMARY

In one embodiment, a capacitance module may include a first substrate having a first side and a second side opposite the first side, and a second substrate having a third side and a fourth side opposite the third side. The second side of the first substrate may face the third side of the second substrate. A first set of electrodes may be disposed on the second side of the substrate, and a second set of electrodes may also be disposed on the second side of the substrate. The first set of electrodes and the second set of electrodes may be capacitance measuring electrodes.

A portion of the second set of electrodes may be routed on the third side of the second substrate.

A dielectric material may be disposed between the second side of the first substrate and the third side of the second substrate. A portion of the second set of electrodes may be routed through vias formed in the dielectric.

The dielectric may be made a magnetically conductive, electrically insulating material.

The dielectric may be made of a ferrite material.

The second portion of the second set of electrodes may be electrically insulated from an electrically conductive shield formed on the third side of the second substrate.

A strain gauge may be located on the first side of the substrate

The third side of the second substrate may include material having an electrically conductive shield.

A light emitting diode may be located on the first side of the substrate.

A hall effect sensor may be located on the first side of the substrate.

An antenna may be located on the first side of the substrate.

A non-capacitance sensor may be located on the first side of the substrate.

At least one resistor, inductor, field-programmable gate array, or combinations thereof may be disposed on the first side of the substrate.

The second substrate may include memory storing programmed instructions to operate the capacitance module.

In another embodiment, a capacitance module may include a sensor layer having a first side and a second side, at least one non-capacitance component located on the first side of the sensor layer, a shield layer adjacent to the second side of the sensor layer, a first set of electrodes disposed on the second side of the sensor layer, and a second set of electrodes disposed on the second side of the sensor layer. The first set of electrodes and the second set of electrodes may be capacitance measuring electrodes.

The non-capacitance component may include a light emitting diode.

The non-capacitance component may include an antenna.

The location of the non-capacitance component on the first side may overlap with a node formed between the first set of electrodes and the second set of electrodes on the second side.

A portion of the second set of electrodes may be routed to the shield layer through a dielectric material between the sensor layer and the shield layer.

The shield layer may include electrically isolated sections formed on the shield layer. A portion of the second set of electrodes may be routed onto the electrically isolated sections from the second side of the sensor layer.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of a capacitance module in accordance with the disclosure.

FIG. 6 depicts an example of a capacitance module in accordance with the disclosure.

FIG. 7 depicts an example of a capacitance module in accordance with the disclosure.

FIG. 8 depicts an example of a capacitance module in accordance with the disclosure.

FIG. 9a depicts an example of a substrate in accordance with the disclosure.

FIG. 9b depicts an example of a substrate in accordance with the disclosure.

FIG. 10a depicts an example of a substrate in accordance with the disclosure.

FIG. 10b depicts an example of a substrate in accordance with the disclosure.

FIG. 11 depicts an example of a substrate in accordance with the disclosure.

FIG. 12 depicts an example of a substrate in accordance with the disclosure.

FIG. 13 depicts an example of a touchpad in accordance with the disclosure.

FIG. 14 depicts an example of a capacitance module in accordance with the disclosure.

FIG. 15a depicts an example of a personal computer in accordance with the disclosure.

FIG. 15b depicts an example of a personal computer in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

For the purposes of this disclosure, the term “node” may generally refer to a region of two or more overlapping electrodes that are used to measure capacitance. In some examples, a transmit electrode may cross a sense electrode and collectively be part of a capacitance sensing circuit. However, the transmit electrode and the sense electrode may still be positioned so that a gap is present between them to prevent shorting. In some cases, the capacitance measurements sensitivity may be higher where the transmit electrode crosses the sense electrode. In a capacitance module, such regions may be especially sensitive to interference by electrical signals, and electrical components that are located near these regions may be positioned based on location of the node to reduce electrical interference.

For the purposes of this disclosure, the term “anti-node region” may generally refer to a location between nodes. For the purpose of this disclosure, the term “anti-node” may refer to a point in between the more than one node, that is located as far as possible from each of the nodes. In some cases, capacitance measurements may be the least sensitive at the anti-node. In examples where electrical components are located near a capacitance module, placing the electrical components near the anti-node or at least within the anti-node region may reduce electrical interference.

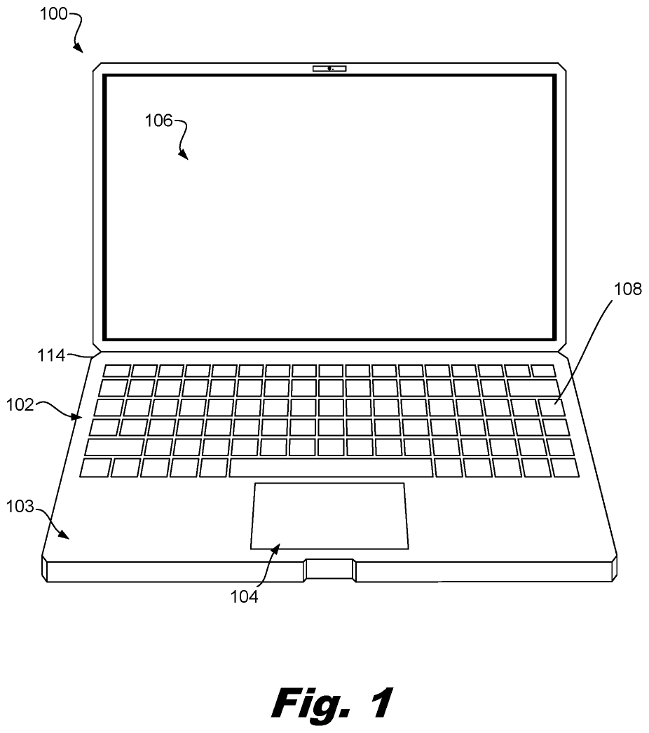

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard's surface where the user's palms may rest while typing. The capacitance module may include a substrate, such as a printed circuit board or another type of substrate. One of the layers of the capacitance module may include a sensor layer that includes a first set of electrodes oriented in a first direction and a second substrate of electrodes oriented in a second direction that is transverse the first direction. These electrodes may be spaced apart and/or electrically isolated from each other. The electrical isolation may be accomplished by deposited at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approach the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user's finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

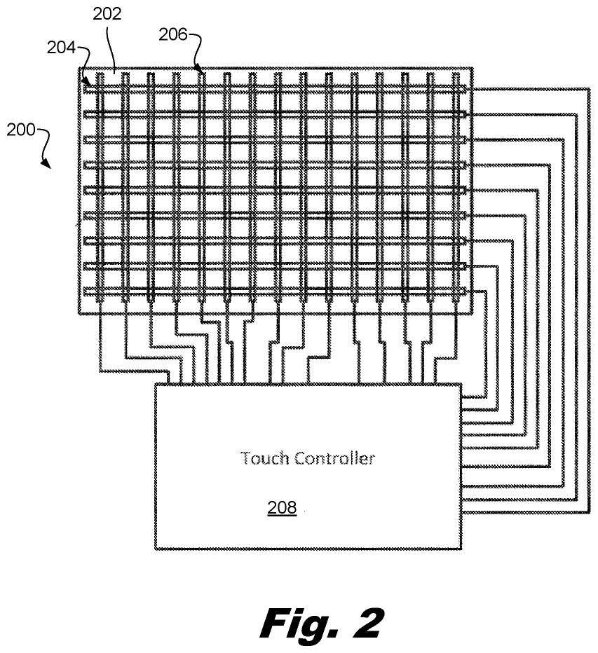

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

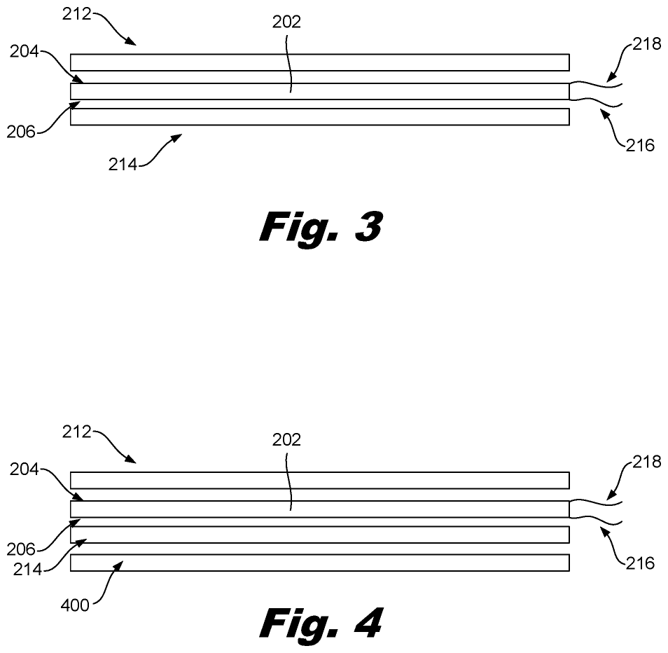

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously. Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user's finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

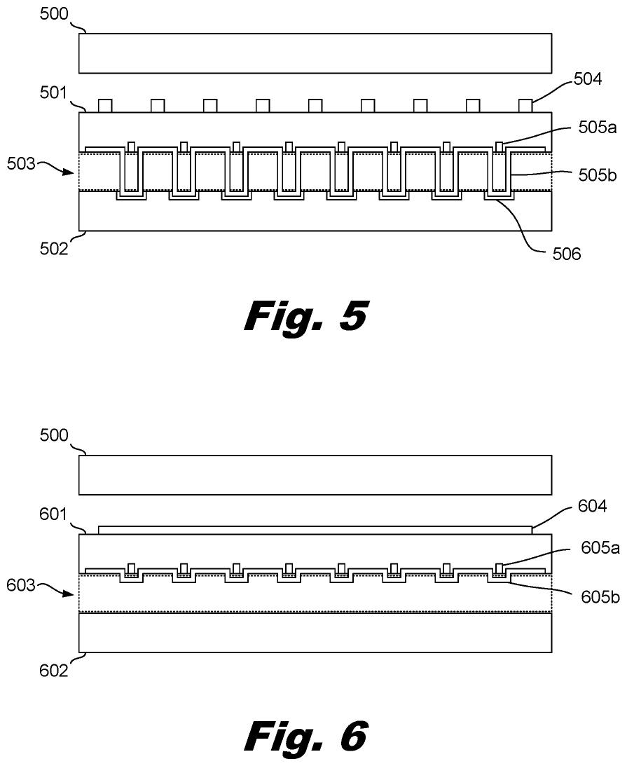

FIG. 5 depicts an example of a capacitance module in accordance with the disclosure. A first substrate 501 of the capacitance module is located adjacent to a second substrate 502 of the capacitance module. A dielectric 503 is located in between the first substrate 501 and the second substrate 502. The first substrate 501 is adjacent to a capacitance reference surface 500. The first substrate 501 may include a first side that is adjacent to the capacitance reference surface 500 and a second side that is opposite of the first side. The second side may be adjacent to the dielectric 503. The second substrate 502 may include a third side that is adjacent to the dielectric 503 and a fourth side that is opposite the third side. The second side of the first substrate 501 and the third side of the second substrate 502 may be inside surfaces of the capacitance module.

In some examples, a user may interact with the capacitance module by touching the capacitance reference surface 500 with a finger, stylus, or other input method. In other examples, a user may interact with the capacitance module by bringing a finger, stylus, or other input method near the capacitance reference surface 500, and the capacitance detects the proximity of the finger, stylus, or other object. The capacitance reference surface 500 may be made of glass, plastic, another material, or combinations thereof. The capacitance reference surface 500 may be an overlay, a keyboard housing surface, another type of surface, or combinations thereof. In some examples, the capacitance reference surface 500 is not part of the capacitance module but is adjacent to the capacitance module. In other cases, the capacitance reference surface 500 may be part of the capacitance module.

The first substrate 501 includes a first set 505a and a second set 505b of electrodes on the second side of the first substrate 501. The first set 505a of electrodes may be generally aligned with the length of the first substrate 501. The second set 505b of electrodes may be generally aligned with the width of the first substrate 501. The electrodes of the second set 505b may cross the electrodes of the first set 505a while maintaining a gap between the electrodes of the first and second sets to avoid electrical shorting. The electrodes of the first set 505a or second set 505b may be transmit electrodes, sense electrodes, another type of electrodes, or combinations thereof. The electrodes of the first set 505a or second set 505b may be made of copper, gold, aluminum, another conductive material, or combinations thereof. The electrodes of the first set 505a or second set 505b may be etched, printed, or otherwise deposited on the second side of the first substrate 501. Together, the first set 505a and the second set 505b of electrodes form a mutual capacitance sensor, a self-capacitance sensor, another type of capacitance sensor, or combinations thereof.

The first set 505a may be electrically isolated from electrodes of the second set. To isolate the electrodes of the first set 505a from the electrodes of the second set 505b, the electrodes may be routed from the second side of the first substrate 501 through the dielectric 503 to the third side of the second substrate 502 where the electrodes are deposited for a relatively short duration and then rerouted from the third side of the second substrate 502 through the dielectric 503 back to the second side of the first substrate 501. In some cases, the electrodes in either set 505a, 505b may span the entire length or width of the first substrate so that the capacitance sensor can sense any location of user input on the capacitance reference surface 500.

The dielectric 503 may be made of an electrically insulating material such as ferrite, ceramic, plastic, adhesive, coating, another electrically insulating material, or combinations thereof. The material of the dielectric 503 may be magnetically conductive and electrically insulating. In cases where it may be desirable for a dielectric to be magnetically conductive and electrically insulating, the dielectric may be made of, at least in part, ferrite, another material with similar properties, or combinations thereof.

In this example, electrodes in the second set 505b are routed through the dielectric 503 and partially disposed on the second substrate 502. The second substrate 502 may be a shield layer, a component layer, another type of layer, or combinations thereof. In cases where the second substrate 502 is a shield layer, the second substrate may be made of copper, nickel, silver, another appropriate shielding material, or combinations thereof.

The second substrate 502 may include electrically isolated sections 506 where the electrodes may be deposited without shorting to the circuitry or other components formed on the third side of the second substrate 502. For example, in embodiments where a shield is deposited on the third side of the second substrate 502, gaps in the shield material may provide sufficient area to deposit a relatively small portion of the rerouted electrode on the third side without the electrode making contact with the shield material. In some cases, the electrically isolated sections 506 are exposed portions of the substrate of the second substrate 502. In other examples, the electrically isolated sections 506 are made of a different material than the shield material or other features of the third side. For example, the electrically isolated sections 506 may be made of an electrically insulating material such as polyethylene, plastic, another non-conductive material, or combinations thereof. The electrodes of the second set 505b may be disposed on the second substrate 502 within the electrically isolated sections 506 so that the electrodes remain electrically isolated from the material of the second substrate.

Disposing the first set 505a and second set 505b of electrodes on the second side of the first substrate 501 may save space within a capacitance module, thus reducing the overall thickness of the capacitance module. Additionally, by placing the first set 505a and second set 505b of electrodes on the second side of the first substrate 501, some electrical elements may be placed on the first side of the first substrate that would otherwise interfere with the electrodes of the capacitance sensor.

For example, for the measurements of the capacitance sensor to provide relatively consistent measurements across the length and width of the capacitance sensor, the electrodes of the first and second set are generally positioned at equal intervals. In some cases, the closer the electrodes are spaced from each other the more sensitive the capacitance sensor may be. Additionally, the closer the electrodes are spaced, the closer the nodes formed between the first and second sets of electrodes may be. Other considerations may affect the placement of electrodes from the first set, the placement of electrodes from the second set, the placement nodes formed between the sets of electrodes, the placement of anti-node regions between the electrodes, the placement of the anti-nodes between the electrodes, the placement of other features related to the capacitance sensing circuit, or combinations thereof. Due to the optimal spacing of these features of the capacitance sensing circuit, additional circuitry or electronic devices may interfere with placement of the circuitry of the capacitance sensing circuits. In cases where the additional circuitry or electronic devices are nonetheless added to the same side as the capacitance sensing circuit, these additional circuitries of electronic devices may operate under less operable conditions to accommodate the capacitance circuit or vice versa.

Conventionally, the first side of the first substrate contains are least a portion of the capacitance sensing circuit so that the capacitance sensing circuit is as close to the capacitance reference surface as possible. By having the capacitance sensing circuit as close to the capacitance reference surface as possible, the sensitivity of the capacitance sensing circuit may increase since the capacitance sensing circuit is closer to the region being measured for changes in capacitance.

However, the principles of this disclosure include moving the electrodes for sensing capacitance off of the closest position to the region for sensing objects in contact with or in proximity to the capacitance reference surface. By locating the electrodes for sensing capacitance to the second side of the first substrate, the first side is available to for placement of other components that may otherwise interfere with optimal placement of the capacitance sensing electrodes. Electrical elements that may be located on the first side of the first substrate 501 may include but are not limited to, light emitting diodes (LEDs), antennas, hall effect sensors, other types of sensors, other types of electrical element, portions of other circuits, non-capacitance sensors, or combinations thereof.

Locating the first set 505a and second set 505b of electrodes on the first side of the first substrate 501 may reduce electrical interference between electrical elements on the first side of the first substrate and the electrodes in the first and second set 505a, 505b. The electrical elements located on the first side of the first substrate 501 and the electrodes in the first set 505a or second set 505b may be electrically independent from each other. In some cases, the electrical elements on the first side of the first substrate may be positioned with more freedom with less regard to the position of nodes, electrodes, anti-node regions, anti-nodes, or other features of the capacitance sensing circuit on the second side of the first substrate.

In the example depicted in FIG. 5, a set of LEDs 504 is located on the first side of the first substrate 501. The LEDs 504 may be activated one at a time, or multiple LEDs may be activated at once. In some examples, a set of LEDs may be just one LED. In other examples, a set of LEDs may include two LEDs, three LEDs, or a different number of LEDs. The LEDs may be placed directly over the nodes of the capacitance sensing electrodes, near the node of the capacitance sensing electrodes, over the anti-node regions, over the anti-node, or combinations thereof. In some cases, the circuitry for the LEDs may provide a minimal amount of electrical inference for the capacitance sensing circuit.

The LEDs may be placed under a region of the capacitance reference surface that may illuminate an icon, a virtual button, an image, another feature, or combinations thereof. Such illuminated features may be placed to shine through the capacitance reference surface in positions that are well suited for user convenience but would otherwise be less suitable for the capacitance sensing circuit if the capacitance sensing circuit and the LEDs were to be secured to the same side of a layer.

When LEDs 504 are illuminated, the light from the LEDs may travel through the capacitance reference surface 500. In some examples, the capacitance reference surface 500 may include transparent sections through which the light from the LEDs 504 may travel. In these examples, the LEDs 504 may be located on the first substrate 501 such that the transparent sections of the capacitance reference surface 500 overlap the LEDs. In other examples, the material of the capacitance reference surface 500 may permit light to travel through the material of the surface when a LED is illuminated without incorporating a more transparent section in the reference capacitance surface.

In examples where the first set 505a and second set 505b of electrodes are disposed on the second side of the first substrate 501, the LEDs 504 on the first side of the first substrate may be positioned on the first side regardless of the position of electrodes in the first set 505a or second set 505b on the second side of the first substrate.

FIG. 6 depicts an example of a capacitance module in accordance with the disclosure. In this example, the capacitance module includes a first substrate 601 with an antenna 604 on the first side of the layer, a first set of electrodes 605a on the second side of the layer, and a second set of electrodes 605b on the second side of the layer. The capacitance module also includes a second substrate 602.

The antenna 601 may be printed, etched, or otherwise deposited on the first substrate 601. The antenna may be made of a material such as copper, silver, another material, or combinations thereof. The antenna may be configured to transmit a wireless signal according to a Wi-Fi protocol, short range wireless communication protocol, Near Field Communication (NFC) protocol, another protocol, or combinations thereof. In some examples, the antenna may be an inductive antenna, an electric antenna, a coil antenna, dipole antenna, RFID, another type of antenna, or combinations thereof.

In this example, a dielectric 603 is located between the first substrate 601 and the second substrate 602. The electrodes of the second set 605b are routed through a portion of the dielectric 603. While the electrodes in FIG. 5 are routed through the entirety of the dielectric 503, in this example, the electrodes are routed through only a portion of the dielectric 603.

In some examples where an antenna is secured to the first side of the first substrate 501, the dielectric material may be made of a magnetically conductive, electrically insulating (MCEI) material that may shield the portions of the capacitance module from the signals of the antenna. In some examples, the MCEI material is made of a ferrite material and may block or redirect inductive signals produced by certain types of antennas. In some examples, the MCEI material may prevent the inductive signal from reaching a shield material formed on the second substrate 502, which may prevent or reduce the formation of eddy currents in the shield material. The elimination or reduction of eddy currents in the shield material may eliminate or reduce the interference from the antenna in the capacitance sensing electrodes.

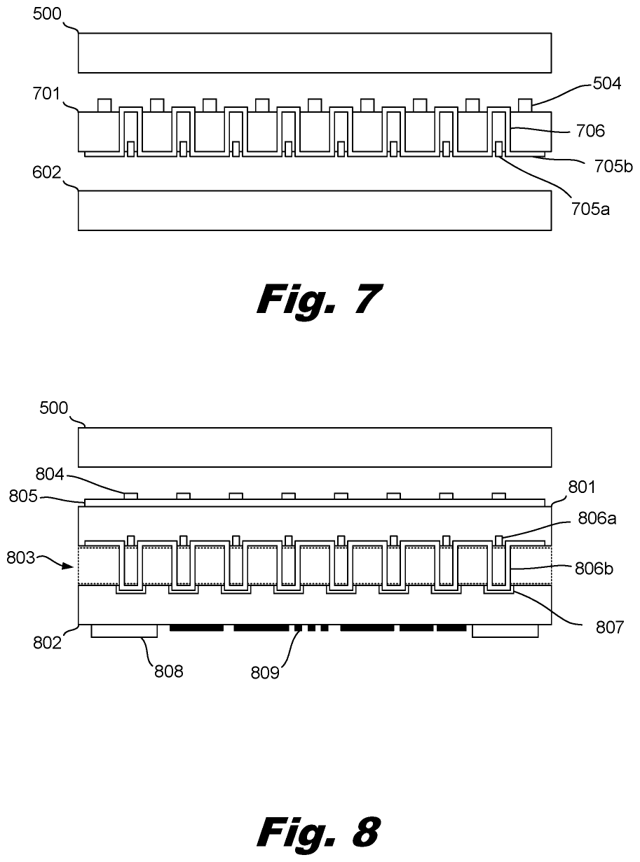

FIG. 7 depicts an example of a capacitance module in accordance with the disclosure. In this example, a first substrate 701 includes a set of LEDs 504 on the first side of the layer. A first set of electrodes 705a and a second set of electrodes 705b are located on the second side of the first substrate 701. A portion of the electrodes in the second set 705b may be routed 706 through the material of the first substrate 701 to the first side of the first substrate 701.

The electrodes in the second set 705b may be routed to locations on the first side of the first substrate 701 based on the location of LEDs 504 on the first side of the first substrate. Routing electrodes to the first side of a layer may reduce the overall thickness of a capacitance module.

FIG. 8 depicts an example of a capacitance module in accordance with the disclosure. In this example, the capacitance module includes the capacitance reference surface 500, a first substrate 801, a second substrate 802, and a dielectric between the first substrate and the second substrate.

While the capacitance module in this example is depicted with three layers, including the capacitance reference surface 500, in other examples, a capacitance module may include more or less layers than depicted. For example, a capacitance module may include two layers, four layers, a different number of layers, or combinations thereof.

While the capacitance module in this example is depicted with the first substrate 801 located between the capacitance reference surface 500 and the second substrate 802, in other examples, the relative location of layers within a capacitance module may differ. For example, in some capacitance modules, a second substrate may be located in between a first substrate and a capacitance reference surface. In another example, a third layer may be incorporated between a first substrate and a second substrate, etc. The relative location of layers within a capacitance module may differ depending on the device that the capacitance module is embodied within.

Multiple electrical elements of different types may be disposed on a first side of a layer. In this example, the first substrate 801 includes an antenna 805 and a set of LEDs 804 located on the first side of the first substrate. The antenna 805 may be formed such that it surrounds the set of LEDs 804.

While the first substrate 801 in this example includes two electrical elements on the first side of the first substrate—the antenna 805 and set of LEDs 804, in other examples, a different number of electrical elements may be included on the side of a layer. In some examples, the mutual capacitance sensor is formed on the second side of the first substrate 801, greater freedom may be afforded to the location of electrical elements on the first side of the first substrate, which may make it easier to include more electrical elements than otherwise.

The first substrate 801 includes a first set 806a of electrodes and a second set of electrodes 806b on the second side of the first substrate. The electrodes in the first set 806a may cross electrodes from the second set 806b. Together, the first and second set 806a, 806b of electrodes form a mutual capacitance sensor.

A portion of the second set of electrodes 806b may be routed through the dielectric 803 between the first substrate 801 and the second substrate 802. By routing the electrodes through the dielectric, the electrodes of the first set 806a may remain electrical isolated from the electrodes of the second set 806b. The electrodes of the second set 806b may be partially disposed on electrically isolated portions 807 of the second substrate 802.

The second substrate 802 may include haptic actuators 808 located on the second side of the second substrate. The haptic actuators 808 may be piezoelectric actuators, eccentric rotating mass actuators, linear resonant actuators, another type of haptic actuator, or combinations thereof. The haptic actuators 808 may be used to deliver haptic feedback to a user by generating a haptic vibration. While this example identifies two haptic actuators 808, in other examples a capacitance module may include more or less haptic actuators. For example, a capacitance module may include one haptic actuator, four haptic actuators, a different number of haptic actuators, or combinations thereof.

The second substrate 802 may include components 809 on the second side of the second substrate. The components 809 may include electrical components that are used to operate the capacitance module. The components 809 may include, but are not limited to, a central processing unit (CPU), a digital signal processor (DSP), an analog front end (AFE), an amplifier, a peripheral interface controller (PIC), another type of microprocessor, an integrated circuit (ASIC), a combination of logic gate circuitry, other types of digital or analog electrical components, or combinations thereof.

The capacitance module in this example includes five elements: the set of LEDs 804, the antenna 805, the mutual capacitance sensor formed by the first set 806a of electrodes and the second set 806b of electrodes, the haptic actuators 808, and the components 809. In some capacitance modules, including five elements may include five layers. By forming both sets 806a, 806b of electrodes on one side of the first substrate 801 and disposing a portion of the second set 806b of electrodes on one side of the second substrate 802, the number of layers needed to contain the elements may be dramatically reduced, decreasing the overall thickness of the capacitance module.

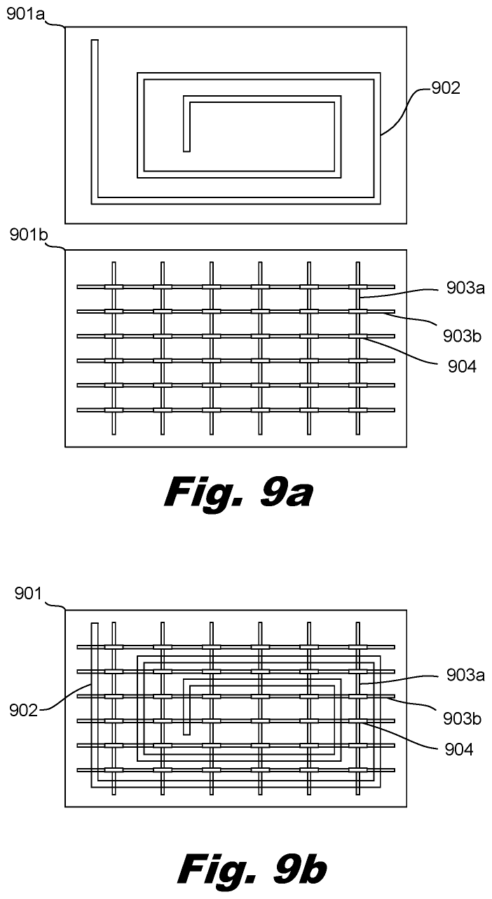

A great advantage of forming a mutual capacitance sensor on one side of a substrate is the ability to place electrical elements on the other side of the substrate without respect to the electrodes of the mutual capacitance sensor. FIG. 9a depicts an example of a substrate in accordance with the disclosure. In this example, the substrate includes a first side 901a and a second side 901b. In some examples. the substrate may be a printed circuit board. In other examples, the substrate may be made of a material such as glass, plastic, metal, another material, or combinations thereof.

The first side 901a includes an antenna 902. The antenna 902 may be etched, deposited, or otherwise formed on the first side 901a of the substrate. The antenna may be configured to transmit a wireless signal according to a Wi-Fi protocol, short-range wireless communication standard, NFC protocol, another type of wireless protocol, or combinations thereof.

The shape of an antenna may have an effect on the antenna's ability to transmit a wireless signal according to specific protocols. In this example, the antenna 902 has a spiral shape, which may increase the effectiveness of transmitting a wireless signal according to an NFC protocol. In other examples, an antenna may have a different shape.

The second side 901b of the substrate includes a mutual capacitance sensor formed by a first set 903a of electrodes and a second set 903b of electrodes. The electrodes of the second set 903b include overlapping sections 904 where the electrodes in the second set 903b are routed over the electrodes of the first set 903a. The overlapping sections 904 may keep the electrodes from the second set 903b electrically independent from the electrodes of the first set 903a.

For illustrative purposes, FIG. 9b depicts the substrate of FIG. 9a with the first side 901a superimposed 901 on the second side 901b. The location of the antenna 902 formed on the first side 901a may be based, in part, on the location of electrodes on the second side 901b. In this example, the antenna 902 is formed such that the material of the antenna overlaps the anti-node regions of the mutual capacitance sensor formed by the first set 903a of electrodes and the second set 903b of electrodes.

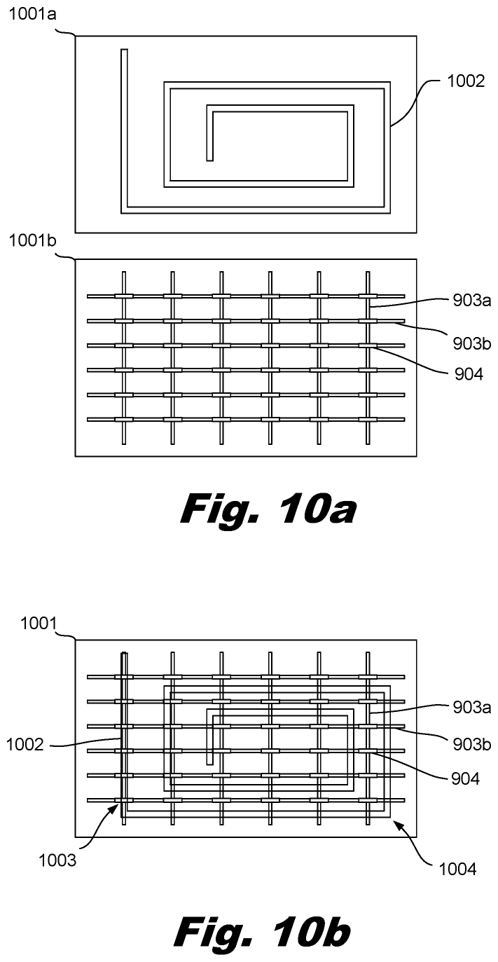

FIG. 10a depicts an example of a substrate in accordance with the disclosure. In this example, the substrate includes a first side 1001 and a second side 1001. An antenna 1002 is formed on the first side 1001 of the substrate, and a mutual capacitance sensor is formed by the first set 903a of electrodes and the second set 903b of electrodes.

For illustrative purposes, FIG. 10b depicts the first side 1001a superimposed 1001 on the second side 1001b of the substrate. In this example, as opposed to the example depicted in FIG. 9b, portions of the antenna 1002 overlap nodes 1003 in the mutual capacitance sensor formed by the first set 903a and second set 903b of electrodes. Other portions of the antenna 1002, such as a portion 1004, are offset from nodes of the mutual capacitance sensor.

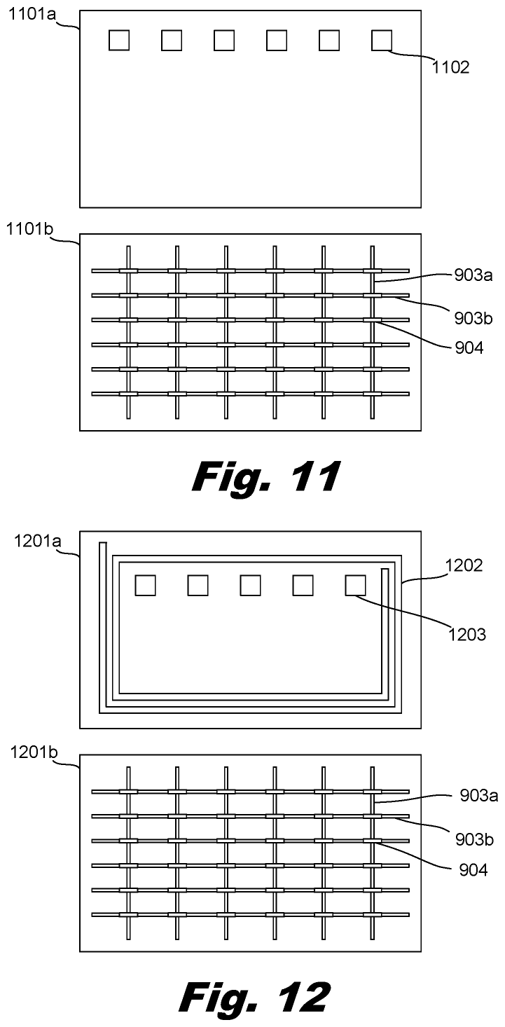

FIG. 11 depicts an example of a substrate in accordance with the disclosure. In this example, the substrate includes a first side 1101a and a second side 1101b.

The first side 1101a includes a set of LEDs 1102 located on one portion of the first side. While the substrate in this example includes six LEDs 1102, in other examples, a substrate may include a different number of LEDs. The LEDs 1102 may be activated individually and/or simultaneously.

The second side 1101b includes a mutual capacitance sensor formed by the first set of electrodes 903a and the second set of electrodes 903b. The electrodes of the second set 903b include overlapping sections 904 which overlap the electrodes of the first set 903a.

By forming the first set of electrodes 903a and second set of electrodes 903b on the second side 1101 of the substrate, the LEDs 1102 may be positioned with a great degree of freedom on the first substrate 1101a while remaining electrically independent from the mutual capacitance sensor formed by the electrodes.

FIG. 12 depicts an example of a substrate in accordance with the disclosure. In this example, the substrate includes a first substrate 1201a and a second substrate 1201b. The first substrate 1201a includes a set of LEDs 1203 and an antenna 1202. The second substrate 1201b includes a mutual capacitance sensor formed by the first set 903a of electrodes and the second set 903b of electrodes.

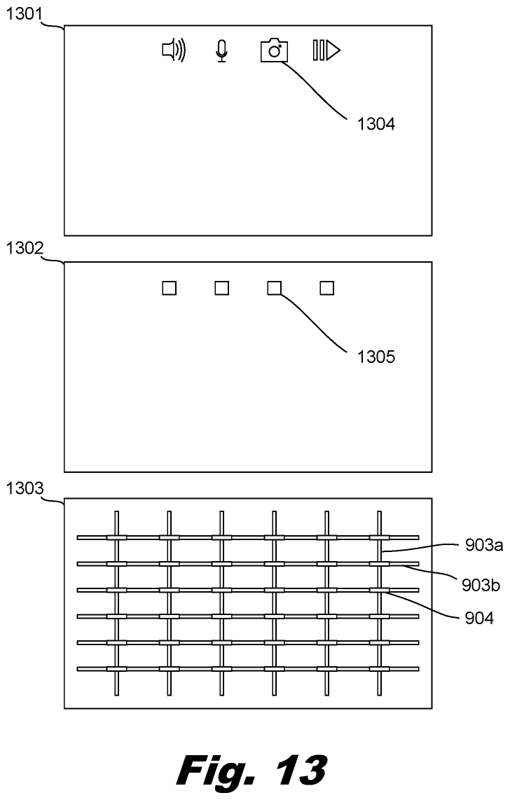

FIG. 13 depicts an example of a touchpad in accordance with the disclosure. In this example, the touchpad includes a capacitance reference surface 1301 and a substrate including a first side 1302 and a second side 1303.

The first side 1302 of the substrate is located adjacent to the capacitance reference surface. The first side 1302 of the substrate includes a set of LEDs 1305. The second side 1303 of the substrate includes a mutual capacitance sensor formed by the first set 903a of electrodes and the second set 903b of electrodes.

A user may interact with the touchpad by touching the capacitance reference surface 1301 with a finger, stylus, or other input method. The capacitance reference surface 1301 may be an overlay, a keyboard housing, another type of surface, or combinations thereof. When a user touches the capacitance reference surface 1301, the touch may be detected by the mutual capacitance sensor formed by the first set 903a and second set 903b of electrodes. Once the touchpad has detected the user touch, components in the touchpad may interpret the sensor input from the mutual capacitance sensor and interpret the input as data.

The capacitance reference surface 1301 may include touch icons 1304. In some examples, the touch icons 1304 may be defined as discontinuities through the material of the capacitance reference surface 1301. In such examples, the LEDs 1305 on the first side 1302 of the substrate adjacent to the capacitance reference surface 1302 may illuminate the discontinuities of the touch icons 1304. In other examples, the capacitance reference surface 1301 may be a continuous material, and the touch icons 1304 may be defined as illuminations originating from the LEDs 1305 on the first side 1302 of the adjacent substrate which may be visually perceived through the material of the capacitance reference surface.

The capacitance reference surface 1301 includes four touch icons 1304. The four touch icons 1304 have four individual shapes: (from left to right) a volume shape, a microphone shape, a camera shape, and a play/pause shape. In other examples, touch icons on a capacitance reference surface may differ in quantity and/or shape. Additionally, in some examples, the shape of a touch icon may change contextually.

The touchpad may activate a certain hardware or software feature when a user touches a touch icon 1301 on the capacitance reference surface 1301. The shape of a touch icon 1304 may correspond to the activated function. For example, touching the touch icon with the volume shape may toggle the activation of a microphone in communication with the touchpad. In another example, touching the touch icon with the camera shape may toggle the activation of a camera device in communication with the touchpad. In some examples, the icons may be illuminated when the associated virtual keys are activated. In some cases, the virtual keys associated with the icons may be activated when a video call is initiated, or another type of software program is initiated.

Forming the mutual capacitance sensor on the second side 1303 of a substrate in the touchpad may enable greater freedom in placing touch icons 1304 on the capacitance reference surface 1301. Because the LEDs 1305 may be located on the first side 1302 without respect to electrodes in the first set 903a and second set 903b, touch icons 1304 may be placed with greater consideration to practical use by an end user, without being held back by constraints imposed by the location of electrodes.

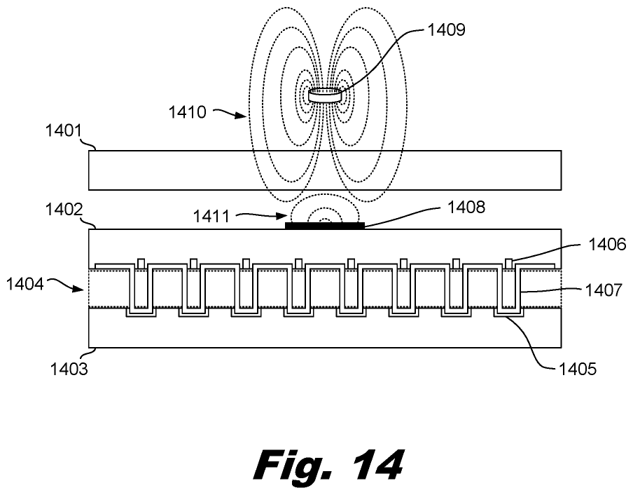

FIG. 14 depicts an example of a capacitance module in accordance with the disclosure. In this example, the capacitance module includes a capacitance reference surface 1401, a first substrate 1402 adjacent to the capacitance reference surface, a second substrate 1403 adjacent to the first substrate, and a dielectric 1404 in between the first substrate and the second substrate.

The first substrate 1402 includes a hall effect sensor 1408 located on the first side of the first substrate. The hall effect sensor 1408 may generate an electric field 1411. When a magnetic field approaches the electric field 1411 generated by the hall effect sensor 1408, the sensor may detect the presence and magnitude of the magnetic field. When a magnetic field has been detected by the hall effect sensor 1408, the sensor may generate a hall voltage. The hall voltage may be proportional to the magnitude of the magnetic field detected by the hall effect sensor 1408.

In this example, a magnet 1409 is located near the capacitance module. The magnet 1409 generates a magnetic field 1410. The hall effect sensor 1408 may detect the presence of the magnetic field 1410 through the capacitance reference surface 1401 and may generated a hall voltage proportional to the magnitude of the magnetic field. When the hall voltage of the hall effect sensor 1408 exceeds a certain threshold, the capacitance module may send a digital or analog signal. The signal generated by the capacitance module from the hall effect sensor 1408 may be received by hardware or software in communication with the capacitance module. The signal generated by the capacitance module may be configured for a variety of applications. For example, the signal may be used to deactivate a hardware device such as a screen, tick a hardware or software counter, cause another hardware or software event, or combinations thereof.

The first substrate 1402 also includes a mutual capacitance sensor located on the second side of the first substrate. The mutual capacitance sensor may be formed by a first set of electrodes 1406 and a second set of electrodes 1407. The electrodes in the second set 1407 may be partially routed through the material of the dielectric 1404. The electrodes in the second set 1407 may be partially formed on electrically isolated sections 1405 of the second substrate 1403.

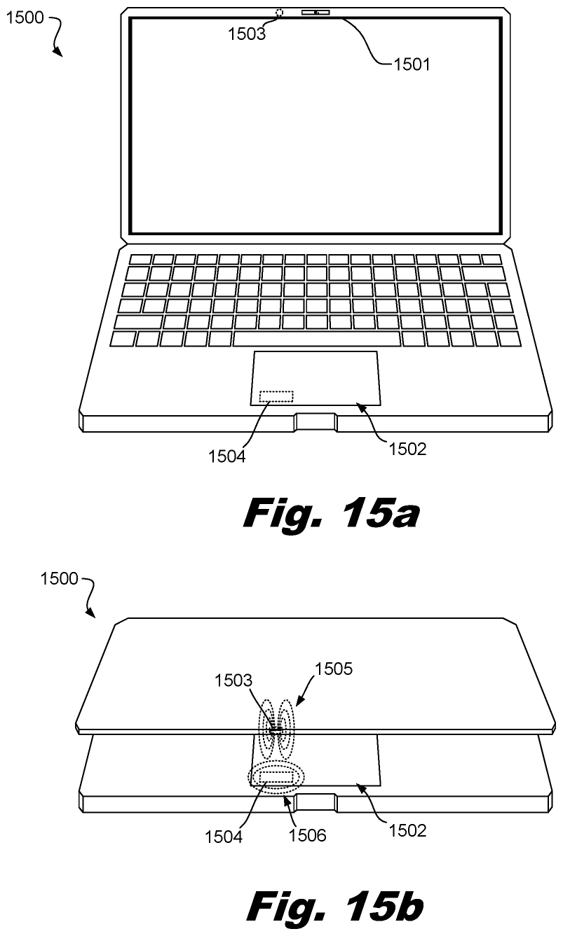

FIG. 15a depicts an example of a personal computer 1500 in accordance with the disclosure. In this example, the personal computer 1500 is a laptop. The personal computer 1500 includes a bezel 1501 and a magnet 1503 embedded within the bezel.

The personal computer 1500 may include a capacitance module 1502 incorporated into the computer as a touchpad. The capacitance module 1502 may include a hall effect sensor 1504. In this example, the hall effect sensor 1504 is embedded within the capacitance module 1502 and hidden from view. In other examples, a hall effect sensor may be visible from the outside of a device.

For illustrative purposes, FIG. 15b depicts the personal computer 1500 as it is being closed. The magnet 1503 within the personal computer 1500 may generate a magnetic field 1505. The hall effect sensor 1504 within the capacitance module 1502 of the personal computer 1500 may generate an electric field 1506. As the laptop is closed, the magnetic field 1505 may be brought into closer proximity with the electric field 1506 generated by the hall effect sensor 1504. As the magnetic field 1505 and electric field 1506 become closer, the hall effect sensor 1504 may generate a hall voltage, which may cause the capacitance module 1502 to generate a signal. The signal generated by the capacitance module 1502 may cause the personal computer 1500 to enter a low power state or turn off completely.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a first substrate having a first side and a second side opposite the first side;
a light emitting diode located on the first side of the first substrate;
a second substrate having a third side and a fourth side opposite the third side;
the second side of the first substrate facing the third side of the second substrate;
a first set of electrodes disposed on the second side of the first substrate; and
at least a portion of a second set of electrodes disposed on the third side of the second substrate;
an electrically conductive shield positioned to protect the first set of electrically conductive electrodes and the second set of electrically conductive electrodes from electromagnetic interference;
wherein the first set of electrodes and the second set of electrodes are capacitance measuring electrode;
wherein the first set of electrically conductive electrodes is between the electrically conductive shield and the light emitting diode.

2. The module of claim 1, wherein the at least portion of the second set of electrodes is routed from the second side of the first substrate to the third side of the second substrate.

3. The module of claim 2, further comprising a magnetically conductive, electrically insulating dielectric material between the second side of the first substrate and the third side of the second substrate and the portion of the second set of electrodes is routed through vias formed in the magnetically conductive, electrically insulating dielectric material.

4. (canceled)

5. (canceled)

6. The module of claim 3, wherein the second set of electrodes is electrically insulated from an electrically conductive shield formed on the third side of the second substrate.

7. The module of claim 1, further comprising a strain gauge located on the first side of the first substrate.

8. (canceled)

9. (canceled)

10. The module of claim 1, further comprising a hall effect sensor located on the first side of the first substrate.

11. The module of claim 1, further comprising an antenna located on the first side of the first substrate.

12. The module of claim 1, further comprising a non-capacitance sensor on the first side of the first substrate.

13. (canceled)

14. The apparatus of claim 1, wherein the second substrate comprises memory storing programmed instructions to operate the capacitance module.

15. A capacitance module, comprising:
a sensor layer having a first side and a second side;
at least one non-capacitance sensor located on the first side of the sensor layer;
a shield layer adjacent to the second side of the sensor layer;
a first set of electrodes disposed on the second side of the sensor layer; and
a second set of electrodes disposed on the second side of the sensor layer;
wherein the first set of electrodes and the second set of electrodes are capacitance measuring electrodes.

16. The module of claim 15, wherein the at least one non-capacitance component includes a strain gauge.

17. The module of claim 15, wherein the at least one non-capacitance component includes a hall effect sensor.

18. The module of claim 15, wherein the location of the at least one non-capacitance sensor on the first side overlaps with a node formed between the first set of electrodes and the second set of electrodes on the second side.

19. The module of claim 15, wherein a portion of the second set of electrodes is routed to the shield layer through a dielectric material between the sensor layer and the shield layer.

20. The module of claim 19, further comprising electrically isolated sections formed on the shield layer, wherein a portion of the second set of electrodes is routed onto the electrically isolated sections from the second side of the sensor layer.

21. The module of claim 15, the non-capacitance sensor includes at least one resistor, inductor, field-programmable gate array, or combinations thereof disposed on the first side of the first substrate.

22. A capacitance module, comprising:
a first substrate having a first side and a second side opposite the first side;
an antenna located on the first side of the first substrate;
a second substrate having a third side and a fourth side opposite the third side;
the second side of the first substrate facing the third side of the second substrate;
a first set of electrodes disposed on the second side of the first substrate; and
at least a portion of a second set of electrodes disposed on the third side of the second substrate;
an electrically conductive shield positioned to protect the first set of electrically conductive electrodes and the second set of electrically conductive electrodes from electromagnetic interference;
wherein the first set of electrodes and the second set of electrodes are capacitance measuring electrodes;
wherein the first set of electrically conductive electrodes is between the electrically conductive shield and the antenna.

23. The module of claim 22, further comprising a magnetically conductive, electrically insulating dielectric material between the second side of the first substrate and the third side of the second substrate and the portion of the second set of electrodes is routed through vias formed in the magnetically conductive, electrically insulating dielectric material.
